(19) United States
(12) Patent Application Publication
(10) Pub. No.: US 2009/0278888 A1
(43) Pub. Date: Nov. 12, 2009

(54) LIQUID EJECTION APPARATUS

(75) Inventors: Yosuke Nakano, Suwa-shi (JP); Katsunari Kumagai, Okaya-shi (JP); Satoshi Hamano, Matsumoto-shi (JP); Tetsuya Tamura, Shiojiri-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/436,223

(22) Filed: May 6, 2009

(30) Foreign Application Priority Data
May 7, 2008 (JP) 2008-120954
Apr. 3, 2009 (JP) 2009-090773

(51) Int. Cl. B41J 2/165

(52) U.S. Cl. 347/34

(57) ABSTRACT

A liquid ejection apparatus including a carriage 8 that moves a head capable of ejecting liquid back and forth in a first direction D1 and a second direction D2 opposite to the first direction D1, a linear scaler 9 that is provided along the first direction D1 and the second direction D2, for recognizing the position of the carriage 8, and a mist guide 21 that is provided so as to be extended from the carriage 8 so as to face the linear scaler 9. The mist guide 21 includes the first slope surface 21b forming the acute slope angle R2 with respect to the first direction D1 and the second slope surface 21a forming the acute slope angle R1 with respect to the second direction D2.

### BACKGROUND OF THE INVENTION

1. Field of the Invention

The present invention relates to a liquid ejection apparatus.

2. Description of the Related Art

In a liquid ejection apparatus, such as an ink jet printer, that moves a medium, such as a sheet, in a sub scanning direction while moving a carriage mounting a head capable of ejecting liquid, such as ink, back and forth in a main scanning direction, thereby forming images on the medium, a stripe pattern drawn on a linear scaler is detected by a detector such as an optical sensor, whereby it is possible to obtain positional information in the main scanning direction. When ink mist produced from the ink ejected from the head adheres to the linear scaler, the detection accuracy of the detector detecting the stripe pattern decreases. Therefore, an unfavorable situation might occur such that the accuracy of the position detection in the main scanning direction decreases. When the accuracy of the position detection decreases, unfavorable situations such as the quality of the images formed on the medium deteriorating or collisions between the carriage and a portion of the frame structure disposed on the moving shaft of the carriage in the main scanning direction might occur.

Therefore, Patent Document 1, for example, proposes a technique that blocks the ink mist emitted from the head by providing a shielding plate between a carriage transport belt and a linear scaler, thereby reducing the amount of the ink mist adhering to the linear scaler.

Patent Document 1: JP-A-2005-81691

### SUMMARY OF THE INVENTION

However, in some cases, ink droplets ejected from the head do not land on a medium such as a sheet but float as ink mist in the air near the head. Such ink mist floating in the air may come into the gap between the linear scaler and the shielding plate and adhere to the linear scaler. Therefore, there is a problem in that the position detection accuracy decreases.

The invention aims to solve at least part of the above-described problems and can be actualized as a form or an application described below.

### [Application 1]

A liquid ejection apparatus including: a carriage that moves a head, capable of ejecting liquid, back and forth in a first direction and a second direction opposite to the first direction; a linear scaler that is provided along the first direction and the second direction for recognizing the position of the carriage; and a mist guide that is provided so as to be extended from the carriage so as to face the linear scaler, characterized in that the mist guide includes a first slope surface forming an acute slope angle with respect to the first direction and a second slope surface forming an acute slope angle with respect to the second direction.

According to such a configuration, the mist guide includes the first slope surface forming the acute slope angle with respect to the first direction and the second slope surface forming the acute slope angle with respect to the second direction. Owing to such a configuration, when the carriage is moved back and forth in the first direction and the second direction, the ink mist floating in the air collides with the first slope surface and the second slope surface, whereby the ink mist is moved in a direction away from the linear scaler. Therefore, it is possible to reduce the amount of the ink mist adhering to the linear scaler. Accordingly, it is possible to suppress the deterioration in the position detection accuracy.

### [Application 2]

The liquid ejection apparatus characterized in that a surface of the mist guide facing the linear scaler is formed as a flat surface which is arranged in parallel to the first direction and the second direction.

According to such a configuration, it is possible to minimize the space existing between the linear scaler and the mist guide. Owing to such a configuration, it is possible to prevent the floating ink mist from entering into the space existing between the linear scaler and the mist guide, and accordingly, it is possible to reduce the amount of the ink mist adhering to the linear scaler. Accordingly, it is possible to suppress the deterioration in the position detection accuracy.

### [Application 3]

The liquid ejection apparatus characterized in that the width of the mist guide is larger than the width of the carriage in the first direction and the second direction.

According to such a configuration, the areas of the first slope surface and the second slope surface can be increased. Owing to such a configuration, it is possible to increase the area of the surface colliding with the ink mist, and accordingly, the amount of the ink mist moving in a direction away from the linear scaler can be increased. Moreover, it is possible to decrease the exposure time of the linear scaler when the carriage moves back and forth in the first direction and the second direction. Therefore, it is possible to reduce the amount of the ink mist adhering to the linear scaler. Accordingly, it is possible to suppress the deterioration in the position detection accuracy.

### [Application 4]

The liquid ejection apparatus characterized in that: it further comprises a frame that holds a guide for guiding the carriage in the direction for main scanning; and the frame includes an interference prevention portion which is provided on the moving trajectory of the mist guide by the reciprocating movement of the carriage so as to prevent the interference between the frame and the mist guide.

According to such a configuration, it is possible to further increase the width of the mist guide in the first direction and the second direction, and accordingly, the amount of the ink mist moving in a direction away from the linear scaler can be increased. Therefore, it is possible to reduce the amount of the ink mist adhering to the linear scaler. Accordingly, it is possible to suppress the deterioration in the position detection accuracy.

### [Application 5]

The liquid ejection apparatus characterized in that the mist guide is further provided with planar members at the side surfaces of the mist guide in the first direction and the second direction, the planar members having surfaces forming a slope angle with respect to the first direction and the second direction.

According to such a configuration, the mist guide is provided with the planar members at the side surfaces thereof, which have surfaces forming a slope angle with respect to the first direction and the second direction. Owing to such a configuration, when the carriage moves in the first direction and the second direction, the ink mist collides with the surfaces, which are provided on the planar members, so as to form the slope angle with respect to the first direction and the second direction, whereby the ink mist is moved in a direction away from the linear scaler. Therefore, it is possible to reduce the amount of the ink mist adhering to the linear scaler. Accordingly, it is possible to suppress the deterioration in the position detection accuracy.

### [Application 6]

The liquid ejection apparatus characterized in that: it comprises a timing belt for moving the carriage back and forth; and the mist guide is provided midway between the linear scaler and the timing belt in a direction perpendicular to the first direction.

According to such a configuration, the timing belt is positioned on a side opposite to the linear scaler with the mist guide being disposed between them. Owing to such a configuration, the ink mist can be attracted toward the timing belt, and accordingly, it is possible to prevent the ink mist from adhering to the linear scaler, which is positioned on the side opposite to the timing belt.

### BRIEF DESCRIPTION OF THE DRAWINGS

FIG. 1 is an external perspective view of an ink jet recording apparatus.

FIG. 2 is an external perspective view of a sensor and a mist guide provided to a carriage.

FIG. 3 is a view of the mist guide, as viewed from a rear surface side of the ink jet printer.

FIG. 4 is an explanatory view illustrating the state where ink mist is removed by the mist guide.

FIG. 5 is an external perspective view of a mist guide provided to the carriage, according to a second embodiment.

FIG. 6 is a view of the mist guide, as viewed from the rear surface side of the ink jet printer.

FIG. 7 is an external perspective view of a mist guide which is provided to the carriage, according to a third embodiment.

FIG. 8 is an external perspective view of an ink jet printer according to a fourth embodiment.

FIG. 9 is an external perspective view of a mist guide provided with a planar member according to a fifth embodiment.

FIG. 10 is a view of a mist guide provided with a planar member according to the fifth embodiment.

FIG. 11 is an external perspective view of a portion provided with a planar member according to the fifth embodiment.

FIG. 12 is a view of the planar member according to the fifth embodiment.

FIG. 13 is a view illustrating the shape of a flat surface formed on a mist guide according to a modified embodiment, as viewed from a rear surface side of the ink jet printer.

FIG. 14 is an external perspective view of a portion formed with a mist guide 21 according to a sixth embodiment.

### DETAILED DESCRIPTION OF EMBODIMENTS

Hereinafter, the description of embodiments will be provided with reference to the drawings.

### First Embodiment

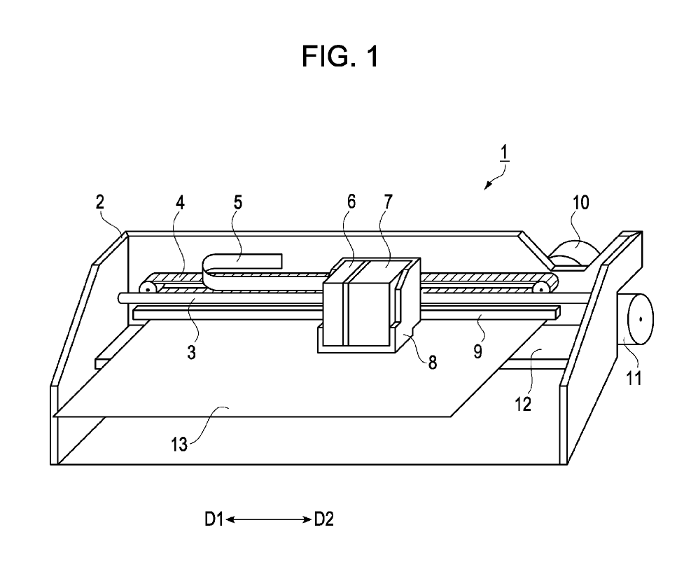

FIG. 1 is an external perspective view of an ink jet printer 1 as an image forming apparatus, as viewed from a front surface side thereof. A carriage motor 10 drives a timing belt 4 under the control of a controller (not shown) which is provided to the ink jet printer 1. A carriage 8 is fixed to the timing belt 4 and moves back and forth along a guide shaft 3, fixed to a frame 2, in a first direction D1 and a second direction D2 opposite to the first direction D1. On the carriage 8, an ink cartridge (monochrome) 6 and an ink cartridge (color) 7 are mounted. A sheet 13, used as a medium, is transported on a platen 12 by a sheet transport motor 11 and a sheet transport mechanism (not shown), both of which are driven by the controller, in a direction perpendicular to the first direction D1 and the second direction D2.

A head (not shown) is provided on the lower portion of the carriage 8 shown in FIG. 1. The head is provided with piezoelectric elements (not shown) so as to correspond to respective nozzles. The ink jet printer 1 is capable of ejecting monochrome ink and colored ink (yellow, magenta, and cyan) from the head by driving the piezoelectric elements in accordance with a control signal transmitted from the controller via a flexible cable 5. The ink jet printer 1 is capable of ejecting ink from the head so as to form images on the sheet 13 by repeating the transport of the sheet 13 and the reciprocating movement of the carriage 8 in the first direction D1 and the second direction D2.

A linear scaler 9 is statically supported by a support member (not shown) which is fixed to the frame 2. On a surface of the linear scaler 9 at a side opposite to the carriage 8 a stripe pattern (not shown), composed of a plurality of vertical lines, each extending in the vertical direction of the drawing, is drawn in the first direction D1 and the second direction D2.

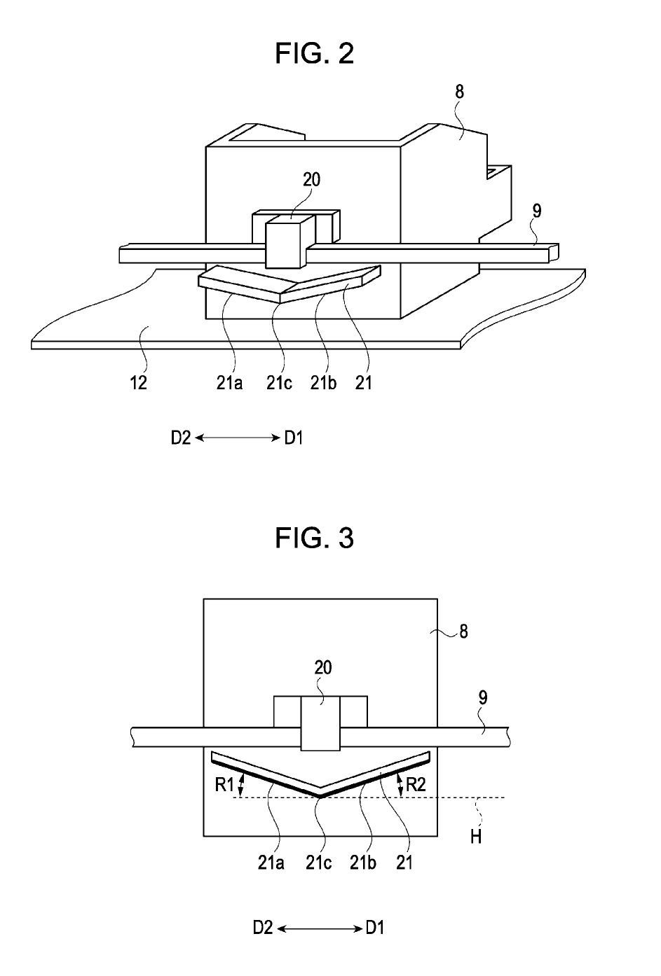

FIG. 2 is an external perspective view of a sensor 20 and a mist guide 21, which are provided to the carriage 8 disposed on the upper side of the platen 12 in the drawing, as viewed from the rear surface side of the ink jet printer 1 shown in FIG. 1, namely from the side of the guide shaft 3. The sensor 20 provided to the carriage 8 is capable of detecting the number of vertical lines that constitute the stripe pattern drawn on the linear scaler 9 in accordance with the movement of the carriage 8 in the first direction D1 and the second direction D2, thereby detecting the amount of movement of the carriage 8 in the first direction D1 and the second direction D2. In this way, the controller controlling the movement of the carriage 8 in the first direction D1 and the second direction D2 can obtain the positional information of the head provided to the carriage 8.

As shown in FIG. 2, the mist guide 21 is provided on the side of the linear scaler 9 on the side of the carriage 8. The mist guide 21 is disposed between the head provided on the lower side of the carriage 8 in the drawing and the linear scaler 9.

FIG. 3 is a view of the mist guide 21 as viewed from the rear surface side of the ink jet printer 1 shown in FIG. 1. On the right side of the mist guide 21 in FIG. 3, a first slope surface 21b forming an acute slope angle R2 with respect to the first direction D1, denoted by the broken line H, is formed. On the left side of the mist guide 21, a second slope surface 21a forming an acute slope angle R1 with respect to the second direction D2 denoted by the broken line H is formed.

As denoted by the bold solid line in FIG. 3, the first slope surface 21b and the second slope surface 21a form a V-shape of which the apex 21c is positioned at a side opposite to the linear scaler 9, when seen from the rear surface side of the ink jet printer 1.

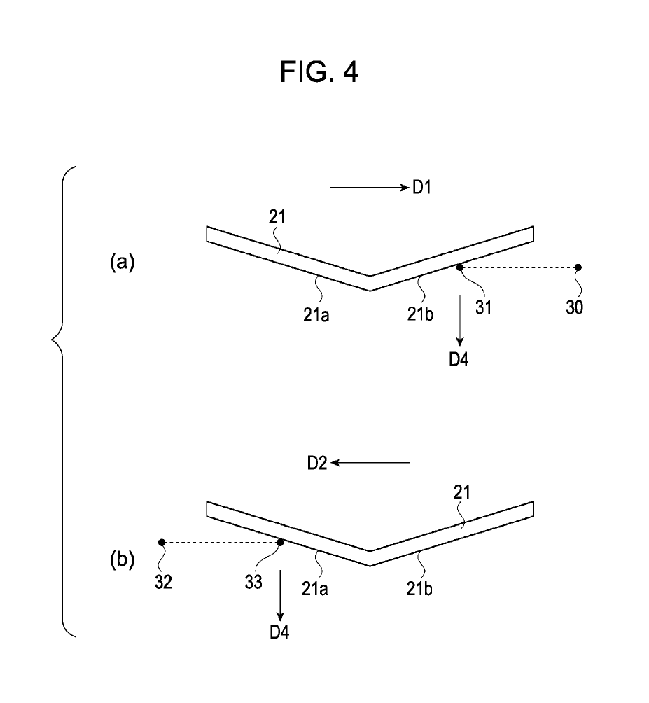

FIG. 4A is an explanatory view illustrating the state where the ink mist is removed by the mist guide 21 when the carriage 8 is moved in the first direction D1. When the carriage 8 moves in the first direction D1, the ink mist 30 which is floating in the air collides with the first slope surface 21b of the mist guide 21 (the colliding ink mist is denoted by 31) and moves in the downward direction D4 indicated in the drawing. In this way, the ink mist 30, (31) which is floating in the air, is moved in a direction away from the linear scaler 9 and is thus removed from the vicinity of the mist guide 21.

FIG. 4B is an explanatory view illustrating the state where the ink mist is removed by the mist guide 21 when the carriage 8 is moved in the second direction D2. When the carriage 8 moves in the second direction D2, the ink mist 32, which is floating in the air, collides with the second slope surface 21a of the mist guide 21 (the colliding ink mist is denoted by 33) and moves in the downward direction D4 indicated in the drawing. In this way, the ink mist 32 (33), which is floating in the air, is moved in a direction away from the linear scaler 9 and removed from the vicinity of the mist guide 21.

As described above, the ink jet printer 1 described in the present embodiment includes: the carriage 8 that moves the head capable of ejecting liquid back and forth in the first direction D1 and the second direction D2, which is opposite to the first direction D1; the linear scaler 9 that is provided along the first direction D1 and the second direction D2, for recognizing the position of the carriage 8; and the mist guide 21 that is provided so as to be extended from the carriage 8 so as to face the linear scaler 9. The mist guide 21 includes the first slope surface 21b, forming the acute slope angle R2 with respect to the first direction D1, and the second slope surface 21a, forming the acute slope angle R1 with respect to the second direction D2.

According to such a configuration, when the carriage 8 is moving back and forth in the first direction D1 and the second direction D2, the ink mists 30 (31) and 32 (33), which are floating in the air, collide with the first slope surface 21b and the second slope surface 21a, respectively, whereby the ink mists 30 (31) and 32 (33) are moved in a direction away from the linear scaler 9. Therefore, the amount of the ink mist adhering to the linear scaler 9 can be decreased, and the deterioration in the position detection accuracy can be prevented.

### Second Embodiment

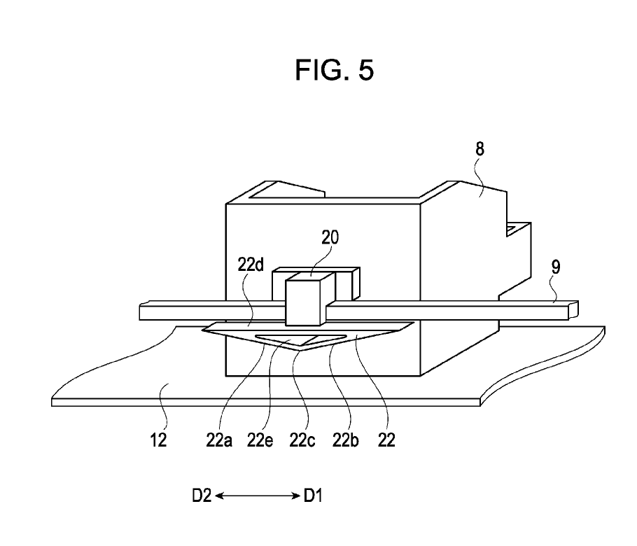

In the second embodiment, the case where a flat surface of the first direction D1 and the second direction D2 is provided on the side of the mist guide which is opposite to the linear scaler 9 will be described. Although the mist guide according to the second embodiment is different from the mist guide 21 according to the first embodiment, the configuration of the ink jet printer as the image forming apparatus according to the second embodiment is identical to that of the ink jet printer 1 described in the first embodiment. FIG. 5 is an external perspective view of the portion having the mist guide 22 mounted thereon, as viewed from the rear surface side of the ink jet printer according to the second embodiment.

As described in the first embodiment, with reference to FIGS. 2 and 3, a sensor 20 capable of detecting a stripe pattern drawn on the linear scaler 9 is provided to the carriage 8 disposed on the upper side of the platen 12 in FIG. 5.

The carriage 8 is provided with the mist guide 22 which is disposed between the head provided on the lower portion of the carriage 8 and the linear scaler 9.

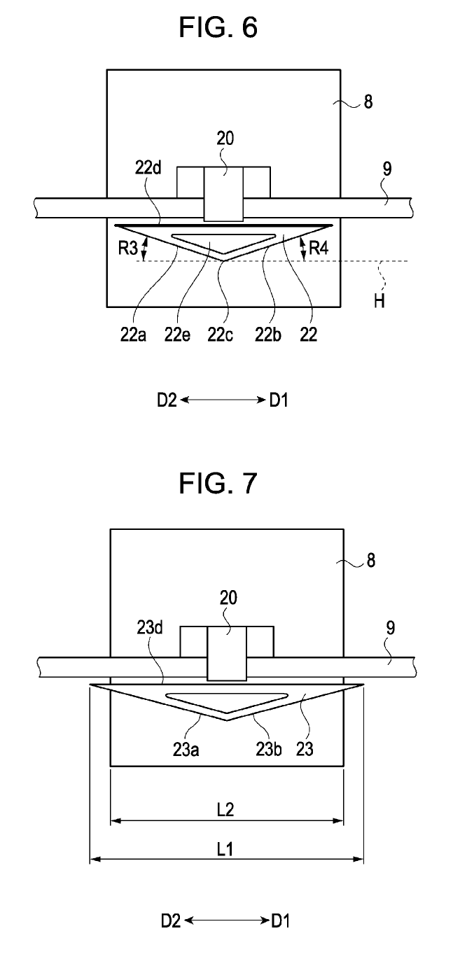

FIG. 6 is a view of the mist guide 22 as viewed from the rear surface side of the ink jet printer according to the second embodiment. On the right side of the mist guide 22 in FIG. 6, a first slope surface 22b forming an acute slope angle R4 with respect to the first direction D1, denoted by the broken line H, is formed. On the left side of the mist guide 22, a second slope surface 22a forming an acute slope angle R3 with respect to the second direction D2, denoted by the broken line H, is formed.

When seen from the rear surface side of the ink jet printer according to the second embodiment, the first slope surface 22b and the second slope surface 22a shown in FIG. 6 form a V-shape of which the apex 22c is positioned at a side opposite to the linear scaler 9.

As denoted by the bold solid line, a flat surface 22d arranged in parallel to the first direction D1 and the second direction D2 is formed on the side of the mist guide 22 opposite the linear scaler 9. The flat surface 22d is arranged at a position in the vicinity of the lower end portion of the sensor 20 in the vertical direction of the drawing so that the lower end portion of the sensor 20 and the flat surface 22d are not brought into contact with each other when the carriage 8 is moved back and forth in the first direction D1 and the second direction D2.

In the present embodiment, the mist guide 22 is formed of resin to be integral with the carriage 8, for example. Therefore, a cavity 22e is defined in the mist guide 22 in order to maintain dimensional precision.

As described above, in the ink jet printer described in the present embodiment, the flat surface 22d of the mist guide 22 which is even with the linear scaler 9 is formed as the flat surface which is arranged in parallel to the first direction D1 and the second direction D2.

According to such a configuration, it is possible to minimize the space existing between the linear scaler 9 and the mist guide 22. Owing to such a configuration, it is possible to prevent the floating ink mist from entering into the space existing between the linear scaler 9 and the mist guide 22, and accordingly, it is possible to reduce the amount of the ink mist adhering to the linear scaler 9. Consequently, it is possible to suppress the deterioration in the position detection accuracy.

### Third Embodiment

In the third embodiment, the case where the width of the mist guide is larger than the width of the carriage in the first direction D1 and the second direction D2 will be described. Although the mist guide according to the third embodiment is different from the mist guide 21 according to the first embodiment, the configuration of the ink jet printer as the image forming apparatus according to the third embodiment is identical to that of the ink jet printer 1 described in the first embodiment. FIG. 7 is an external perspective view of the portion having the mist guide 23 according to the third embodiment mounted thereon, which is provided to the carriage 8. FIG. 7 is a view as viewed from the rear surface side of the ink jet printer according to the third embodiment.

As illustrated in FIG. 7, the width L1 of the mist guide 23 is larger than the width L2 of the carriage 8 in the first direction D1 and the second direction D2.

In doing so the areas of the first slope surface 23b and the second slope surface 23a, each forming the slope angle with respect to the first direction D1 and the second direction D2, can be increased. Owing to such a configuration, it is possible to increase the areas of the first slope surface 23b and the second slope surface 23a colliding with the ink mist, and accordingly, the amount of the ink mist moving in a direction away from the linear scaler 9 can be increased. Therefore, it is possible to reduce the amount of the ink mist adhering to the linear scaler 9. Accordingly, it is possible to suppress the deterioration in the position detection accuracy.

### Fourth Embodiment

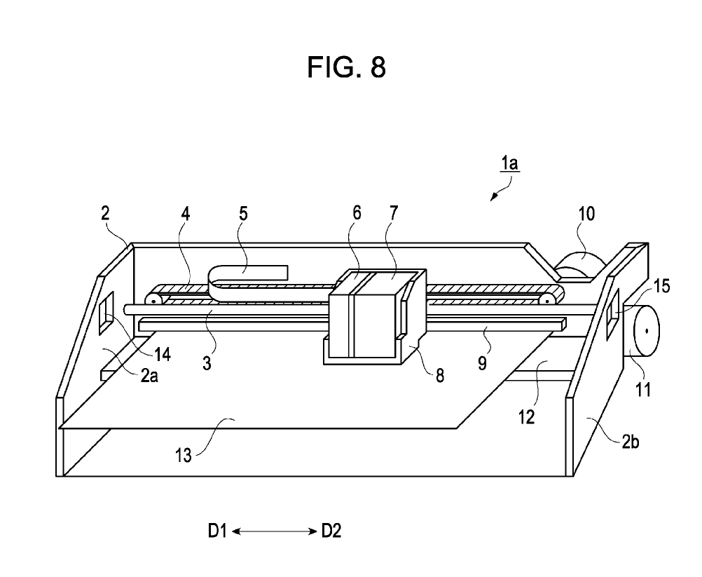

In the fourth embodiment, the case where the frame is provided with an interference prevention portion for preventing interference with the mist guide will be described. FIG. 8 is an external perspective view as viewed from the front surface side of the ink jet printer 1a according to the fourth embodiment. The ink jet printer 1a has the same configuration as the ink jet printer 1 according to the first embodiment, except for the configuration of the side surfaces of the frame.

Similar to the ink jet printer according to the first, second and third embodiments, the ink jet printer 1a according to the fourth embodiment is provided with the frame 2 that holds the guide shaft 3 for guiding the carriage 8 in the direction for the main scanning.

As illustrated in FIG. 8, holes 14 and 15 are formed in the left and right side surfaces of the frame 2. The holes 14 and 15 are defined at positions where a straight line, along which both ends of the mist guide (not shown) mounted on the side of the carriage 8 close to the linear scaler 9 move, intersects the side surfaces 2a and 2b of the frame 2 in the first direction D1 and the second direction D2. That is to say, the holes 14 and 15 formed in the frame 2 are defined on the moving trajectory of the mist guide by the reciprocating movement of the carriage 8.

The holes 14 and 15 are provided so that the mist guide and the frame 2 do not collide with each other when the carriage 8 is moved back and forth in the first direction D1 and the second direction D2, thereby constituting the interference preventing portion which prevents the interference between the mist guide and the frame 2.

Owing to such a configuration that prevents both ends of the mist guide in the first direction D1 and the second direction D2 from colliding with the frame 2, it is possible to increase an allowable reciprocating distance. Therefore, it is possible to further increase the width L1 of the mist guide 23 according to the third embodiment in the first direction D1 and the second direction D2.

### Fifth Embodiment

In the fifth embodiment, the case where the mist guide is further provided with planar members at both ends thereof, which have surfaces forming a slope angle with respect to the first direction D1 and the second direction D2, will be described. Although the mist guide according to the fifth embodiment is different from the mist guide 21 according to the first embodiment, the configuration of the ink jet printer as the image forming apparatus according to the fifth embodiment is identical to that of the ink jet printer 1 described in the first embodiment.

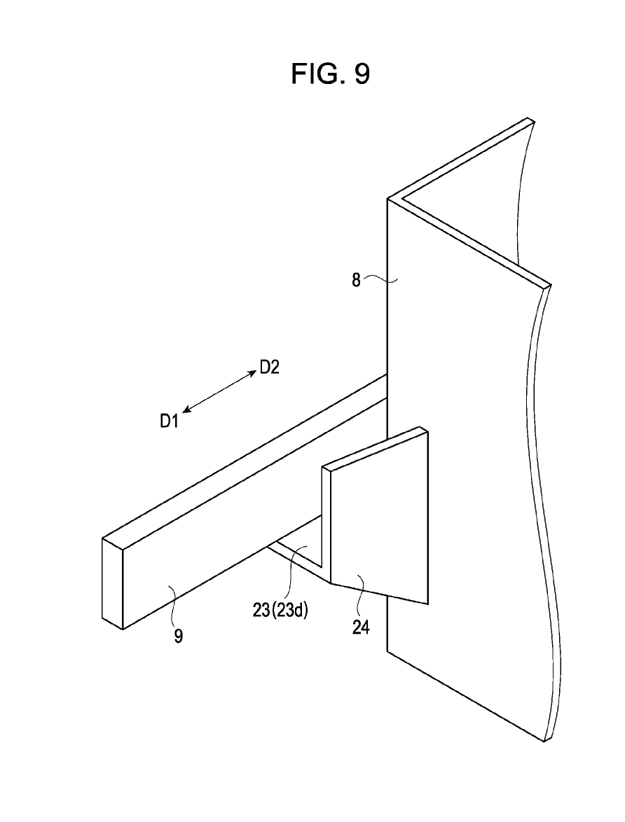

FIG. 9 is an external perspective view of the portion of the mist guide 23 formed with the planar member 24, as viewed from an oblique front surface of the ink jet printer according to the fifth embodiment. FIG. 9 illustrates the mist guide 23 shown in FIG. 7, described in the third embodiment, which is further provided with the planar members 24 at the ends thereof. The planar member 24 shown in FIG. 9 is fixed to the mist guide 23 and the carriage 8.

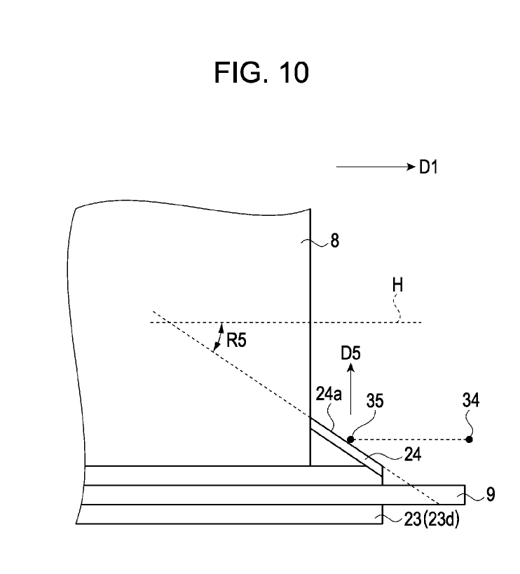

FIG. 10 is a view of the planar member 24 provided to the mist guide 23 and the carriage 8, as viewed from the upper side of FIG. 9. The upper side of FIG. 10 corresponds to the front surface side of the ink jet printer according to the fifth embodiment, whereas the lower side of the drawing corresponds to the rear surface side of the ink jet printer according to the fifth embodiment. The linear scaler 9 is positioned in front of the flat surface 23d of the mist guide 23. As illustrated in FIG. 10, the surface 24a of the planar member 24 and the first direction D1, denoted by the broken line H, form a slope angle R5.

When the carriage 8 moves in the first direction D1, the ink mist 34, which is floating in the air, collides with the surface 24a (the colliding ink mist is denoted by 35) and moves in the upward direction D5 illustrated in the drawing. In this way, the ink mist 34 (35) is moved in a direction away from the linear scaler 9.

The planar member 24 (not shown) is also provided at the end of the mist guide 23 in the second direction D2, so that the planar members 24 are provided at both ends of the mist guide 23 in the first direction D1 and the second direction D2.

According to such a configuration, the mist guide 23 is provided with the planar member 24 formed with the surface 24a forming the slope angle R5 with respect to the first direction D1. Owing to such a configuration, when the carriage 8 is moved in the first direction D1, the ink mist 34 (35) collides with the surface 24a, whereby the ink mist 34 (35) can then be moved in a direction away from the linear scaler 9. Therefore, it is possible to reduce the amount of ink mist adhering to the linear scaler 9.

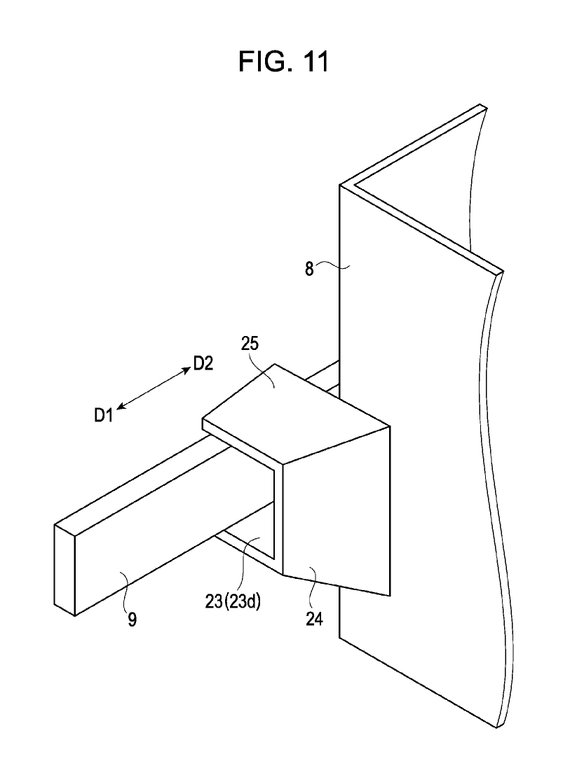

FIG. 11 is an external perspective view of the portion of the mist guide shown in FIG. 9, which is further provided with a planar member 25. The planar member 25 is fixed to the planar member 24 and the carriage 8.

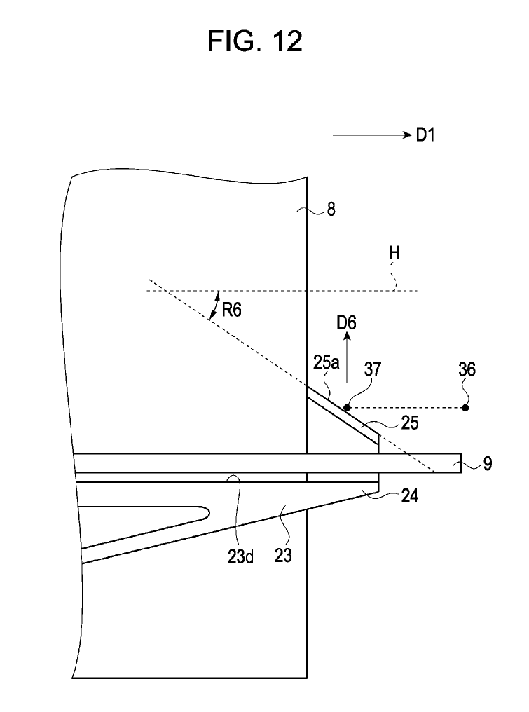

FIG. 12 is a view of the mist guide provided with the planar member 25, as viewed from the rear surface side of the ink jet printer according to the fifth embodiment. The linear scaler 9 is disposed on the upper side of the flat surface 23d of the mist guide 23. As illustrated in FIG. 12, the surface 25a of the planar member 25 and the first direction D1 denoted by the broken line H form an acute slope angle R6.

The planar member 25 (not shown) is also provided at the end of the mist guide 23 in the second direction D2, so that the planar members 25 are provided at both ends of the mist guide 23 in the first direction D1 and the second direction D2.

When the carriage 8 moves in the first direction D1, the ink mist 36 which is floating in the air collides with the surface 25a (the colliding ink mist is denoted by 37) and moves in the upward direction D6 illustrated in the drawing. In this way, the ink mist 36 (37) is moved in a direction away from the linear scaler 9. Accordingly, it is possible to reduce the amount of ink mist adhering to the linear scaler 9 and is possible to suppress the deterioration in the position detection accuracy.

### Sixth Embodiment

In the sixth embodiment, the case where the mist guide 21 is provided midway between the linear scaler 9 and the timing belt 4 in a direction perpendicular to the first direction D1 will be described. FIG. 14 is an external perspective view of the portion formed with the mist guide 21, as viewed from the rear surface side of the ink jet printer according to the sixth embodiment.

A connecting portion 16 provided to the carriage 8 is fixed to a portion of the upper surface of the timing belt 4. The guide shaft 3 passes through a penetration hole 17 formed in the carriage 8. When the timing belt 4 is driven by the carriage motor (not shown), the carriage 8 is moved back and forth along the guide shaft 3 in the first direction D1 and the second direction D2.

As illustrated in FIG. 14, the mist guide 21 is provided midway between the linear scaler 9 and the timing belt 4 so as to intervene between the linear scaler 9 and the timing belt 4 in a direction perpendicular to the first direction D1.

According to such a configuration, the timing belt 4 is positioned on a side opposite to the linear scaler 9 in a direction perpendicular to the first direction D1 with the mist guide 21 being disposed between them. Owing to such a configuration, the ink mist can be attracted toward the timing belt 4 made of rubber, for example, and accordingly, it is possible to prevent the ink mist from adhering to the linear scaler 9, which is positioned on a side opposite to the timing belt 4, with the mist guide 21 being disposed between them.

Other configurations of the ink jet printer according to the sixth embodiment are the same as those of the ink jet printer 1 described in the first embodiment.

### Modified Embodiment

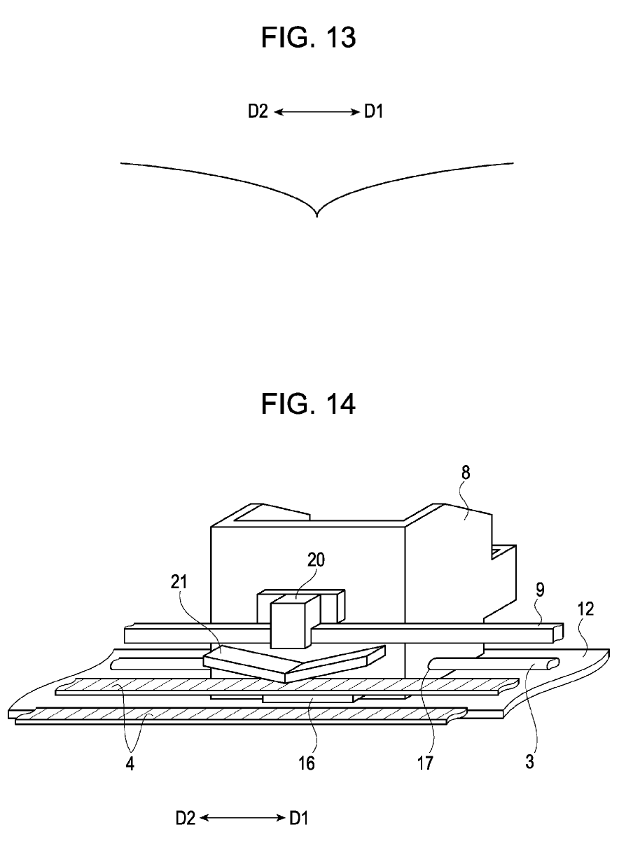

FIG. 13 is a view illustrating the shape of a flat surface formed on the mist guide according to a modified embodiment which is provided to the carriage 8, as viewed from the rear surface side of the ink jet printer. Although the flat surface according to the first to fifth embodiments has a linear V-shape (see FIG. 3), the flat surface may have a curved V-shape as illustrated in FIG. 13.

1. A liquid ejection apparatus comprising,
a carriage that moves a head capable of ejecting liquid back and forth in a first direction and a second direction which is opposite to the first direction;
a linear scaler that is provided along the first direction and the second direction, for recognizing the position of the carriage; and
a mist guide that is provided so as to be extended from the carriage so as to face the linear scaler, characterized in that
the mist guide includes a first slope surface forming an acute slope angle with respect to the first direction and a second slope surface forming an acute slope angle with respect to the second direction.

2. The liquid ejection apparatus according to claim 1, wherein a surface of the mist guide facing the linear scaler is formed as a flat surface which is arranged in parallel to the first direction and the second direction.

3. The liquid ejection apparatus according to claim 1, wherein the width of the mist guide is larger than the width of the carriage in the first direction and the second direction.

4. The liquid ejection apparatus according to claim 3, wherein:
the liquid ejection apparatus further comprises a frame that holds a guide for guiding the carriage in the direction for the main scanning; and
the frame includes an interference prevention portion which is provided on the moving trajectory of the mist guide by the reciprocating movement of the carriage so as to prevent the interference between the frame and the mist guide.

5. The liquid ejection apparatus according to claim 1, wherein the mist guide is further provided with planar members at side surfaces of the mist guide in the first direction and the second direction, the planar members having surfaces forming a slope angle with respect to the first direction and the second direction.

6. The liquid ejection apparatus according to claim 1, wherein:
the liquid ejection apparatus comprises a timing belt for moving the carriage back and forth; and
the mist guide is provided midway between the linear scaler and the timing belt in a direction perpendicular to the first direction.

7. The liquid ejection apparatus according to claim 2, wherein the width of the mist guide is larger than the width of the carriage in the first direction and the second direction.

8. The liquid ejection apparatus according to claim 7, wherein:
the liquid ejection apparatus further comprises a frame that holds a guide for guiding the carriage in the direction for the main scanning; and
the frame includes an interference prevention portion which is provided on the moving trajectory of the mist guide by the reciprocating movement of the carriage so as to prevent the interference between the frame and the mist guide.

9. The liquid ejection apparatus according to claim 8, wherein the mist guide is further provided with planar members at side surfaces of the mist guide in the first direction and the second direction, the planar members having surfaces forming a slope angle with respect to the first direction and the second direction.

10. The liquid ejection apparatus according to claim 9, wherein:
the liquid ejection apparatus comprises a timing belt for moving the carriage back and forth; and
the mist guide is provided midway between the linear scaler and the timing belt in a direction perpendicular to the first direction.
